(19) United States
(12) Patent Application Publication
(10) Pub. No.: US 2007/0185818 A1
(43) Pub. Date: Aug. 9, 2007

(54) Content sales support method and content sales support apparatus in super distribution system

(76) Inventor: Yukiteru Nozawa, Urayasu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/651,492

(22) Filed: Jan. 10, 2007

(30) Foreign Application Priority Data
Jan. 11, 2006 (JP) 2006-004033

(51) Int. Cl. G06Q 99/00

(52) U.S. Cl. 705/51

(57) ABSTRACT

A content sales support apparatus finds the number of possessions for each content of the encrypted contents stored at the user terminals and the average number of possessions of contents. The content sales support apparatus finds the number of purchases for each content of the keys purchased at the user terminals and the average number of purchases of contents. The content sales support apparatus finds a purchase ratio obtained by dividing the number of purchases of a key for each content by the number of possessions of encrypted content. Then, the content sales support apparatus determines a sales measure for each content on the basis of the result of comparison between the found number of purchases of the key for each content, the number of possessions of encrypted content, the purchase ratio, the average number of possessions, and the average number of purchases.

### CROSS-REFERENCE TO RELATED APPLICATIONS

This application is based upon and claims the benefit of priority from prior Japanese Patent Application No. 2006-004033, filed Jan. 11, 2006, the entire contents of which are incorporated herein by reference.

### BACKGROUND OF THE INVENTION

1. Field of the Invention

This invention relates to a super distribution system where a content distributor delivers encrypted content in each content and a key for decrypting the encrypted content into its original content to the user terminals of individual content users separately, and more particularly to a content sales support method, a content sales support apparatus, a content super distribution system, and a content sales support program which obtain sales measures for individual contents.

2. Description of the Related Art

Recently, in the sale and viewing of digital content as represented by documents, music, images, moving pictures, and the like, a content distributor encrypts content and delivers the encrypted content free of charge to each user who wants the content. Then, actually wanting to use (or view) the encrypted content, the user buys from the content distributor a key for decrypting the encrypted content onerously. The key is represented a character string for decryption. Then, the user decrypts the encrypted content into its original content using the key and views the decrypted content. As described above, making “possession” and “purchase” of content independent and then distributing the content is referred to as super distribution.

Generally, distributors of each commodity conduct market research on the sales trend of each commodity in the market. On the basis of the sales trend, they determine a marketing plan (marketing strategy) and put the plan into operation.

For example, Jpn. Pat. Appln. KOKAI Publication No. P2000-29931A has disclosed a marketing data acquisition method of, when providing the user with information according to a predetermined rule, grasping what characteristic a user has and what information the user selects. In this method, however, attention has been merely focused on the user's act of selecting information.

Furthermore, Jpn. Pat. Appln. KOKAI Publication No. P2000-132566A has disclosed relay techniques for enabling content providers to provide users using various terminals with the contents meeting the users' requests. In the disclosed techniques, however, attention has not been focused on the state of distribution and super distribution has not been used.

Moreover, in the “super distribution model” where contents as commodities are divided into “possessions” and “purchases” and these are distributed independently, applicable marketing researches and marketing strategy techniques on the basis of the marketing researches are techniques to which the marketing techniques developed in a conventional distribution model have been applied.

Specifically, the techniques are based on the assumption that, when content is delivered to the user, the content itself and the right granted to the content are delivered inseparably at the same time. Therefore, the result of analysis couldn't help having only such a single viewpoint as what content sells well.

As described above, however, in the super distribution model, for example, the user does not always purchase the keys for all the encrypted contents obtained free of charge and view the contents and may leave the encrypted contents as they are. That is, there are contents possessed but not purchased by the user. Such contents should not be included in the sales figures.

### BRIEF SUMMARY OF THE INVENTION

It is, accordingly, an object of the present invention to provide a content sales support method, a content sales support apparatus, a content supper distribution system, and a content sales support program which are capable of tabulating the possessions and purchases of content for each user in such a manner that they are distinguished from each other, obtaining more accurate sales conditions for each content, and providing content distributors with more exact sales measures.

According to a first aspect of the invention, there is provided a content sales support method of supporting the sale of contents in a super distribution system where a content distribute server delivers encrypted content obtained by encrypting content and a key for decrypting the encrypted content to a plurality of user terminals separately free of charge or for profit, the content sales support method comprising: a step of finding the number of possessions for each content of the encrypted contents stored at the user terminals; a step of finding the number of purchases for each content of the keys purchased at the user terminals; and a step of determining a sales measure for each content on the basis of at least the result of comparison between the found number of purchases of keys for each content and the number of possessions of encrypted content.

In the content sales support method configured as described above, the content distribute server calculates the number of possessions for each content of the encrypted contents delivered from the content distribute server to the individual user terminals and stored there free of charge, that is, the number of possessions for each content work (or content name) and the number of purchases of keys for each content. Comparing the calculated number of possessions and the calculated number of purchases for each content enables the sales condition of each content to be grasped quantitatively. For example, it is possible to grasp the concrete circumstances where the number of purchases of contents is extremely smaller than the number of possessions.

As described above, at the time of analysis, since the number of purchases of contents is distinguished from the number of possessions of contents, a more accurate result of analysis and a more exact proposed sales measure can be obtained than in a conventional marketing approach.

Moreover, using not only the number of possessions for each content of encrypted contents and the number of purchases for each content of keys but also the average number of possessions of encrypted contents for all the contents and the average number of purchases of keys for all the contents, a more accurate result of analysis and a more exact proposed sales measure can be obtained.

According to a second aspect of the invention, there is provided a content sales support apparatus which is incorporated into a super distribution system where a content distribute server delivers encrypted content obtained by encrypting content and a key for decrypting the encrypted content to a plurality of user terminals separately free of charge or for profit and which supports the sale of contents, the content sales support apparatus comprising: means for finding the number of possessions for each content of the encrypted contents held at the user terminals and the average number of possessions of contents; means for finding the number of purchases for each content of the keys purchased at the user terminals and the average number of purchases of contents; means for finding a purchase ratio obtained by dividing the number of purchases of keys for each content by the number of possessions of encrypted content, and means for determining a sales measure for each content on the basis of the result of comparison between the found number of purchases for each content, the number of possessions of encrypted content, the purchase ratio, the average number of possessions, and the average number of purchases.

The content sales support apparatus configured as described above provides almost the same operational advantages as those of the aforementioned content sales support method.

According to a third aspect of the invention, there is provided a content sales support apparatus which is incorporated in a super distribution system where a content distribute server delivers not only encrypted content obtained by encrypting content to a plurality of user terminals via an advertising server but also a key for decrypting the encrypted content to the user terminals and the payment of charge for the key is made between a payment server and the user terminals and which supports the sale of contents, the content sales support apparatus comprising: means for finding the number of possessions for each content of the encrypted contents held at the user terminals and the average number of possessions of contents; means for finding the number of purchases for each content of the keys purchased at the user terminals and the average number of purchases of contents; means for finding a purchase ratio obtained by dividing the number of purchases of keys for each content and the number of possessions of encrypted content, and means for determining a sales measure for each content on the basis of the result of comparison between the found number of purchases for each content, the number of possessions of encrypted content, the purchase ratio, the average number of possessions, and the average number of purchases.

Furthermore, the content sales support apparatus further comprises a statistic storage section which stores the statistics of the number of possessions of each content and the number of purchases of a key for content at a user terminal, the means for finding the number of possessions of each content and the average number of possessions of content including means for updating the number of possessions of content at the statistic storage section when receiving from the advertising server a possession report of having newly possessed encrypted content, and the means for finding the number of purchases of keys for contents and the average number of purchases of keys including means for updating the number of purchases of keys for contents at the statistic storage section when receiving from the payment server a purchase report that the user terminal has newly purchased a key.

In the super distribution system in which the content sales support apparatus configured as described above has been incorporated, not only the content distribute server, user terminals, and content sales support apparatus but also the advertising server and payment server have been incorporated.

Then, when a user terminal has received encrypted content from the content distribute server via the advertising server, the advertising server transmits to the content sales support apparatus a possession report of having newly possessed encrypted content.

Moreover, when a user terminal has made payment for the key purchased from the content distribute server with the payment server, the payment server transmits to the content sales support apparatus a purchase report of having newly purchased a key for encrypted content.

Having received the possession report and purchase report, the content sales support apparatus finds the number of purchases of keys for each content, the number of possessions of encrypted content, the purchase ratio, the average number of possessions, and the average number of purchases and, on the basis of the result of comparison between them, determines a sales measure for each content.

According to a fourth aspect of the invention, there is provided a content sales support program product which is configured in a super distribution system where a content distribute server delivers encrypted content obtained by encrypting content and a key for decrypting the encrypted content to a plurality of user terminals separately free of charge or for profit and which supports the sale of contents, the content sales support program product comprising: finding the number of possessions for each content of the encrypted contents held at the user terminals and the average number of possessions of contents; finding the number of purchases for each content of the keys purchased at the user terminals and the average number of purchases of contents; finding a purchase ratio obtained by dividing the number of purchases of a key for each content by the number of possessions of encrypted content, and determining a sales measure for each content on the basis of the result of comparison between the found number of purchases of a key for each content, the number of possessions of encrypted content, the purchase ratio, the average number of possessions, and the average number of purchases.

The content sales support program configured as described above provides almost the same operational advantages as those of the aforementioned content sales support method.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing a general configuration of a super distribution system in which a content sales support apparatus to which a content sales support method according to a first embodiment of the invention is applied has been incorporated;

FIG. 2 is a block diagram showing a general configuration of a content distribute server incorporated in the super distribution system;

FIG. 3A shows the contents stored in a content table formed in a database of the content distribute server;

FIG. 3B shows the contents stored in an encrypted content table formed in the database;

FIG. 3C shows the contents stored in a key table formed in the database;

FIG. 4 is a block diagram showing a schematic configuration of a user terminal incorporated in the super distribution system;

FIG. 5 is a block diagram showing a schematic configuration of a content sales support apparatus incorporated in the super distribution system;

FIG. 6A shows the contents stored in an index table by content formed in the content sales support apparatus;

FIG. 6B shows the contents stored in a detailed possession table formed in the content sales support apparatus;

FIG. 6C shows the contents stored in a detailed purchase table formed in the content sales support apparatus;

FIG. 6D shows the contents stored in an overall index table formed in the content sales support apparatus;

FIG. 7 is a sequence diagram showing the flow of signals between the content distribute server, user terminal, and content sales support apparatus incorporated in the super distribution system;

FIG. 8 is a schematic view showing a general configuration of a super distribution system in which a content sales support apparatus according to a second embodiment of the invention has been incorporated; and

FIG. 9 is a sequence diagram showing the flow of signals between the content distribute server, advertising server, user terminal, payment server, and content sales support apparatus incorporated in the super distribution system.

### DETAILED DESCRIPTION OF THE INVENTION

Hereinafter, referring to the accompanying drawings, embodiments of the present invention will be explained.

### FIRST EMBODIMENT

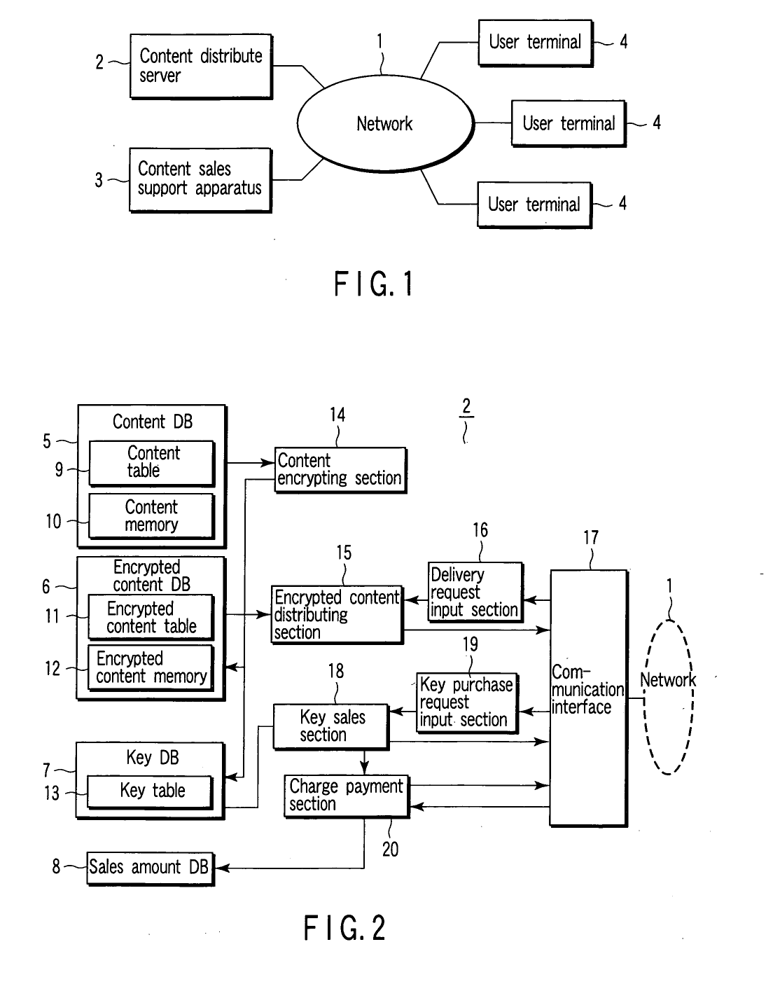

FIG. 1 is a schematic view showing a general configuration of a super distribution system in which a content sales support apparatus to which a content sales support method according to a first embodiment of the invention is applied has been incorporated.

A content distribute server 2, a content sales support apparatus 3, and a plurality of user terminals 4 are connected to a network 1, such as the Internet. The content distribute server 2 and content sales support apparatus 3 are operated at a content distributor firm and each of the user terminals 4 is managed by the end user of each content.

FIG. 2 is a block diagram showing a general configuration of the content distribute server 2 composed of, for example, a computer. In a storage unit, such as a HDD (hard disk drive), provided in the content distribute server 2, a content DB (database) 5, an encrypted content DB 6, a key DB 7, a sales amount DB 8, and others are formed. Further in the content distribute server 2, there is provided a communication interface 17 which exchanges various types of information with an external unit via the network 1.

Still further in the content distribute server 2, there are provided a content encrypting section 14, an encrypted content distributing section 15, a delivery request input section 16, a key sales section 18, a key purchase request section 19, and a charge payment section 20 formed in an application program.

The configuration and operation of each of the sections described above will be explained in sequence.

In the content DB 5, a content memory 10 and a content table 9 are formed. In the content memory 10, a plurality of unencrypted contents to be sold are assigned file names and then stored. In the content table 9, the content ID, content name, copyright owner's name, and file name of each content are stored.

The content ID is an individual number assigned to the content name (or work name) of each content delivered by the content distribute server 2 to each user terminal 4.

The content encrypting section 14 reads each content stored in the content memory 10 of the content DB 5 sequentially and encrypts it. The content encrypting section 14 writes into the key DB 7 not only the encrypted content into the encrypted content DB 6 but also a key for decrypting the encrypted content into its original content.

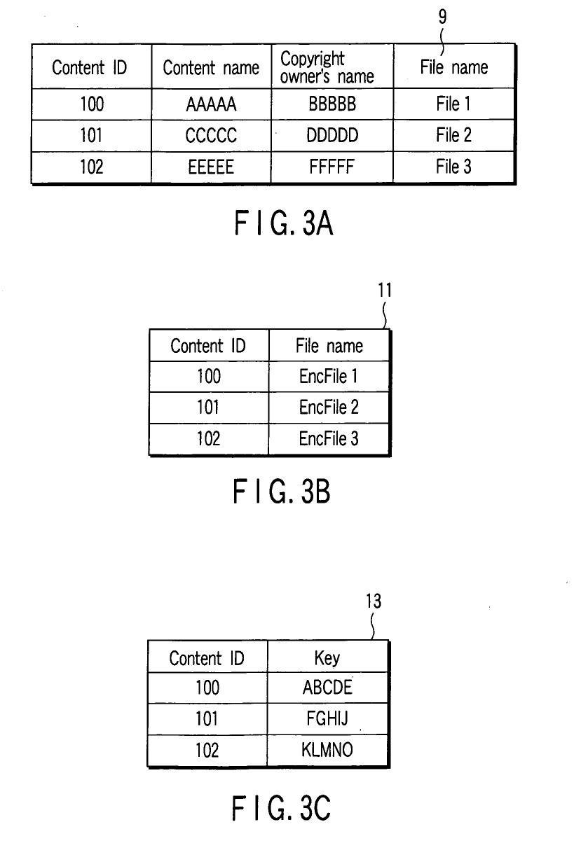

In the encrypted content DB6, an encrypted content memory 12 which stores each encrypted content encrypted at the content encrypting section 14 and an encrypted content table 11 have been formed. In the encrypted content table 11, the content ID of each encrypted content stored in the encrypted content memory 12 and the file name in the encrypted content memory 12 have been stored as shown in FIG. 3B.

In the key DB 7, a key table 13 shown in FIG. 3C has been formed. In the key table 13, a key composed of a combination of a plurality of characters input from the content encrypting section 14 has been stored for the content ID of each encrypted content.

When the user terminal 4 has input a content delivery request via the network 1 and communication interface 17 to the delivery request input section 16, the encrypted content distributing section 15 reads the encrypted content with the content ID specified by the delivery request from the encrypted content DB 6 and transmits the encrypted content via the communication interface 17 and network 1 to the user terminal 4 of the delivery requester.

When the user terminal 4 has input a key purchase request via the network 1 and communication interface 17 to the key purchase request input section 19, the key sales section 18 reads the key with the content ID specified by the key purchase request from the key DB 7 and transmits the key via the communication interface 17 and network 1 to the user terminal 4 of the key purchase requester.

Furthermore, the key sales section 18 starts up the charge payment section 20. The charge payment section 20 makes electronic payment of charge for the key with the user terminal 4 of the key purchaser and registers the charge for the key as the sale proceeds in the sales amount DB 8. As electronic payment, for example, electronic money payment or credit card payment is used.

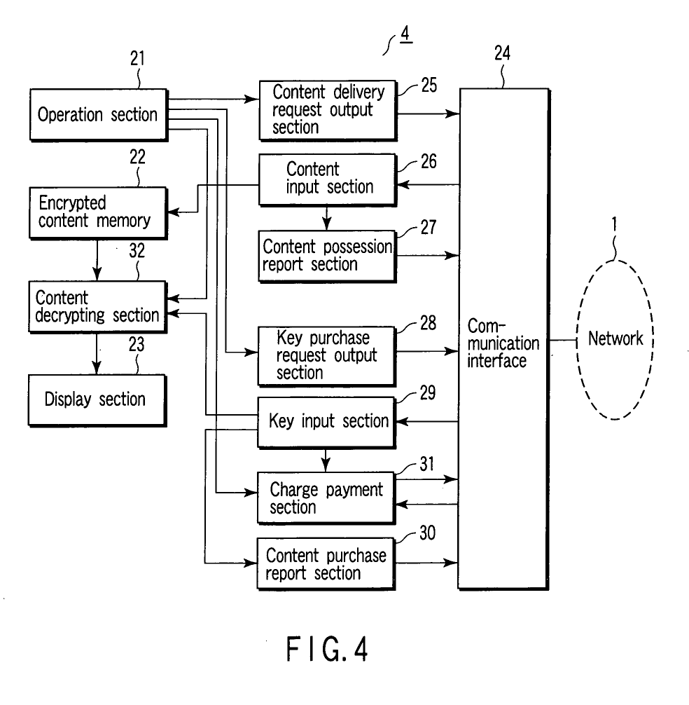

FIG. 4 is a block diagram showing a schematic configuration of each user terminal 4 composed of, for example, a personal computer. In the user terminal 4, there are provided an operation section 21, such as a keyboard, for the user to input various requests, an encrypted content memory 22 formed in a storage section, a display section 23, and a communication interface 24 for exchanging various types of information with an external unit via the network 1.

Further in the content distribute server 2, there are provided a content delivery request output section 25, a content input section 26, a content possession report section 27, a key purchase request output section 28, a key input section 29, a content purchase report section 30, a charge payment section 31, and a content decrypting section 32.

Next, the operation of each of the sections described above will be explained sequentially.

The content delivery request output section 25 transmits a delivery request for content specifying content ID input from the operation section 21 to the content distribute server 2 via the communication interface 24 and network 1. The content input section 26 not only writes the encrypted content received via the network 1 and communication interface 24 from the content distribute server 2 into the encrypted content memory 22 but also starts up the content possession report section 27.

The content possession report section 27 creates a content possession report including the content ID of the received encrypted content, the environment for the reception of encrypted content or for data processing at its own user terminal 4, and the reception date. The content possession report section 27 transmits the created content possession report to the content sales support apparatus 3 via the communication interface 24 and network 1. Here, the environment for reception or data processing at the user terminal 4 is, for example, the type of the OS or browser.

The key purchase request output section 28 transmits a key purchase request specifying the content ID input from the operation section 21 to the content distribute server 2 via the communication interface 24 and network 1. The key input section 29 not only sends the key received from the content distribute server 2 via the network 1 and communication interface 24 to the content decrypting section 32 but also starts up the content purchase report section 30 and charge payment section 31.

The content purchase report section 30 creates a content purchase report including the content ID of the received key, the environment for the reception of the key or for data processing at its own user terminal 4, and the reception date. The content purchase report section 30 transmits the created content purchase report to the content sales support apparatus 3 via the communication interface 24 and network 1.

The charge payment section 31 makes payment for the cost (charge) of the key with the content sales support apparatus 3.

According to an instruction from the operation section 21, the content decrypting section 32 decrypts the encrypted content stored in the encrypted content memory 22 into its original content using the key and outputs the decrypted content on the display section 23, which displays it.

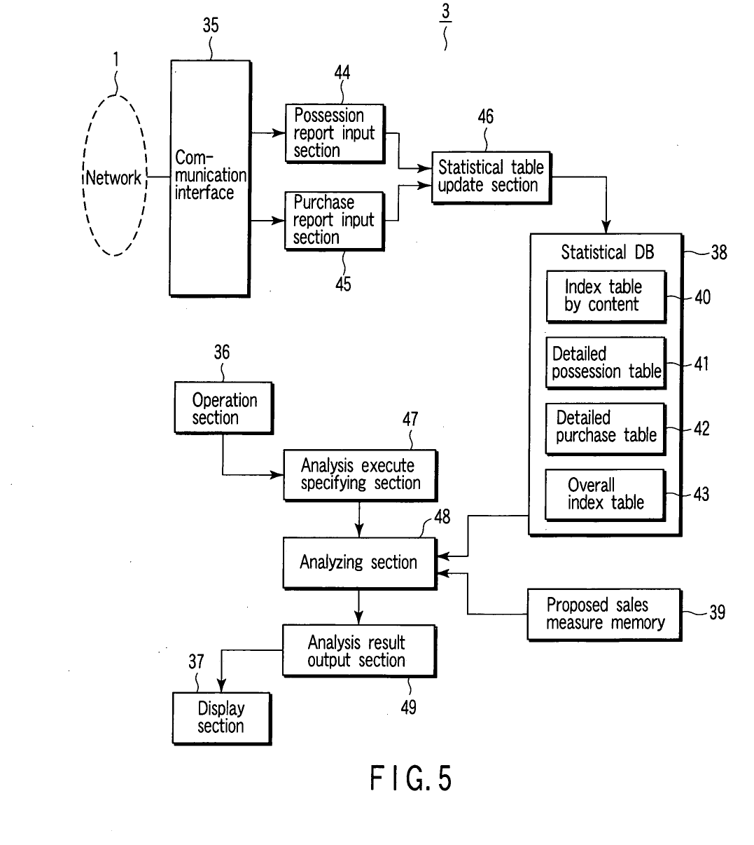

FIG. 5 is a block diagram showing a schematic configuration of the content sales support apparatus 3 composed of, for example, a computer. In the content sales support apparatus 3, there are provided a communication interface 35 for exchanging various types of information with an external unit via the network 1, an operation section 36, such as a keyboard, for an analyzer to input various instructions, a display section 37, a statistical DB 38 formed in a storage unit, such as an HDD, a proposed sales measure memory 39, and others.

In the statistical DB 38 formed in a storage unit, such as an HDD, an index table by content 40, a detailed possession table 41, a detailed purchase table 42, and an overall index table 43 have been formed.

Further in the content sales support apparatus 3, there are a possession report input section 44, a purchase report input section 45, a statistical table update section 46, an analysis execute specifying section 47, an analyzing section 48, and an analysis result output section 49.

Next, the configuration and operation of each of the sections described above will be explained sequentially.

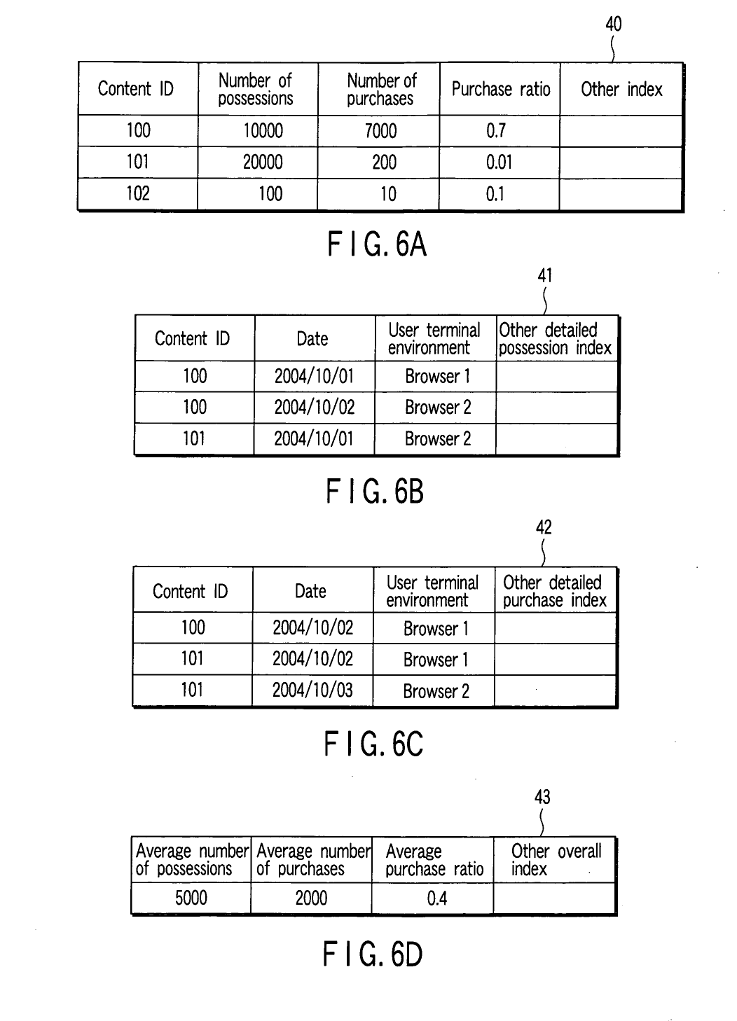

As shown in FIG. 6A, the index table by content 40 holds various pieces of information, including the content ID, the number of possessions, the number of purchases, the purchase ratio of the number of purchases to the number of possessions by type (or by work) in the contents already delivered or to be delivered to each user terminal 4.

As shown in FIG. 6B, in a detailed possession table 41, each content possession report received from each user terminal 4 is stored in time sequence in such a manner that they are sorted by content ID.

As shown in FIG. 6C, in a detailed purchase table 42, each content purchase report received from each user terminal 4 is stored in time sequence in such a manner that they are sorted by content ID.

As shown in FIG. 6D, an overall index table 43 holds information, including the average number of possessions, the average number of purchases, the average purchase ratio calculated over all of the types (all the pieces of work, all the IDs) of contents.

When each user terminal 4 inputs a content possession report to the possession report input section 44 via the network 1 and communication interface 35, the statistical table update section 46 updates the statistics of the individual tales 40, 41, 43 in the statistical DB 38 according to the content possession report. Specifically, the statistical table update section 46 updates the number of possessions and purchase ratio of the corresponding content ID in the index table by content 40, additionally stores the content possession report into the detailed possession table 41, and further updates the average number of possessions and average purchase ratio in the overall index table 43.

Furthermore, when each user terminal 4 inputs a content purchase report to the purchase report input section 45 via the network 1 and communication interface 35, the statistical table update section 46 updates the statistics of the individual tales 40, 42, 43 in the statistical DB 38 according to the content purchase report. Specifically, the statistical table update section 46 updates the number of purchases and purchase ratio of the corresponding content ID in the index table by content 40, additionally stores the content purchase report into the detailed purchase table 42, and further updates the average number of purchases and average purchase ratio in the overall index table 43.

In the proposed sales measure memory 39, the following eight proposed sales measures (a) to (h) have been stored for each content corresponding to a combination of the individual values (or statistics) in the tables 40, 43 after update:

(a) If the number of possessions of the relevant content is larger than the average number of possessions, the number of purchases is larger than the average number of purchases, and the purchase ratio is larger than 0.5, “Attention should be paid to future trends without particular sales promotion costs” is displayed as a proposed measure.

(b) If the number of possessions of the relevant content is larger than the average number of possessions, the number of purchases is larger than the average number of purchases, and the purchase ratio is smaller than 0.5, “The part allowed to be previewed should be reexamined or purchase bonuses should be considered” is displayed as a proposed measure.

(c) If the number of possessions of the relevant content is larger than the average number of possessions, the number of purchases is smaller than the average number of purchases, and the purchase ratio is larger than 0.5, “That's normally impossible” is displayed as a proposed measure.

(d) If the number of possessions of the relevant content is larger than the average number of possessions, the number of purchases is smaller than the average number of purchases, and the purchase ratio is smaller than 0.5, “The sales price should be reexamined” is displayed as a proposed measure.

(e) If the number of possessions of the relevant content is smaller than the average number of possessions, the number of purchases is larger than the average number of purchases, and the purchase ratio is larger than 0.5, “The exposures should be increased in number” is displayed as a proposed measure.

(f) If the number of possessions of the relevant content is smaller than the average number of possessions, the number of purchases is larger than the average number of purchases, and the purchase ratio is smaller than 0.5, “That's normally impossible” is displayed as a proposed measure.

(g) If the number of possessions of the relevant content is smaller than the average number of possessions, the number of purchases is smaller than the average number of purchases, and the purchase ratio is larger than 0.5, “The exposures should be increased in number” is displayed as a proposed measure.

(h) If the number of possessions of the relevant content is smaller than the average number of possessions, the number of purchases is smaller than the average number of purchases, and the purchase ratio is smaller than 0.5, “Overall review should be performed” is displayed as a proposed measure.

When the operation section 36 inputs an analysis execute instruction specifying content ID to the analysis execute specifying section 47, the analyzing section 48 reads the number of possessions of, the number of purchases of, and the purchase ratio of the relevant content ID in the index table by content 40 in the statistical DB 38 and the average number of possessions, the average number of purchases, and the average purchase ratio in the overall index table 43.

Then, the analyzing section 48 determines which one of the eight combinations stored in the proposed sales measure memory 39 coincides with a combination of the read-out values (statistics). The analyzing section 48 determines the proposed sales measure corresponding to the coincident combination to be a proposed sales measure for the relevant content and sends the proposed sales measure to the analysis result output section 49. The analysis result output section 49 outputs the proposed sales measure to the display section 37, which displays it.

The analyzer can operate the operation section 36 as needed to display the contents stored in the detailed possession table 41 and detailed purchase table 42 on the display section 37.

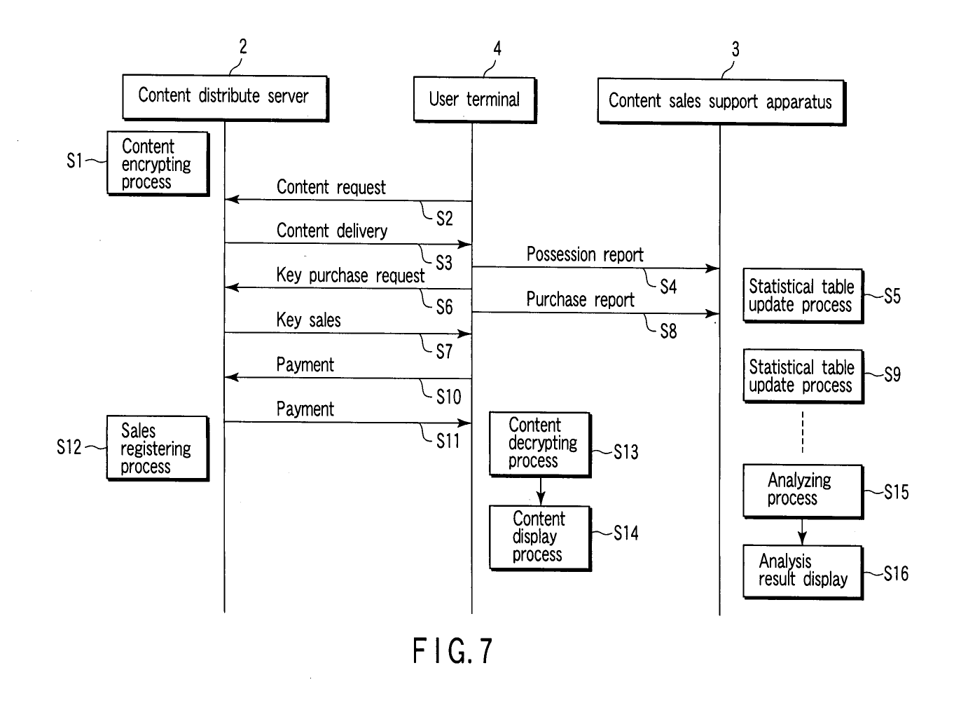

FIG. 7 is a sequence diagram showing the flow of signals between the content distribute server 2, user terminal 4, and content sales support apparatus 3.

First, the content distribute server 2 carries out a content encrypting process (step S1). In this state, the user terminal 4 transmits a content request to the content distribute server 2 (step S2). The content distribute server 2 delivers encrypted content to the user terminal 4 (step S3). Then, the user terminal 4 transmits a content possession report to the content sales support apparatus 3 (step S4). The content sales support apparatus 3 updates each of the tables 40, 41, 43 (step S5).

When the user terminal 4 transmits a key purchase request to the content distribute server 2 (step S6), the content distribute server 2 sells a key to the user terminal 4 (step S7). Next, the user terminal 4 transmits a content purchase report to the content sales support apparatus 3 (step S8). The content sales support apparatus 3 updates each of the tables 40, 42, 43 (step S9). Payment of charge for the key is made between the user terminal 4 and the content distribute server 2 (step S10, step S11). Then, the content distribute server 2 performs a sales registering process on the charge (step S12).

Thereafter, the user terminal 4 decrypts the encrypted content using the key (step S13) and displays the decrypted content (step S14). On the other hand, the content sales support apparatus 3 analyzes the proposed sales measures for each content (step S15) and displays the obtained proposed sales measure (step S16).

In the content sales support apparatus 3 of the first embodiment configured as described above, the user terminal 4 transmits a content request to the content distribute server 2 according to the operation by the content user. Then, when receiving a new encrypted content from the content distribute server 2, the user terminal 4 transmits to the content sales support apparatus 3 a content possession report about the possession of a new encrypted content.

Furthermore, when the user terminal 4 of each content user purchases a new key for decrypting the encrypted content from the content distribute server 2, the terminal 4 transmits a content purchase report about the purchase of a new key to the content sales support apparatus 3.

Having received the content possession report and content purchase report, the content sales support apparatus 3 updates the statistics of the number of possessions of contents and the number of purchases of contents in the index table by content 40, detailed possession table 41, detailed purchase table 42, and overall index table 43 stored in the statistical DB 38. Then, analyzing each of the updated statistics, the content sales support apparatus 3 determines a proposed sales measure for each content.

As described above, since possessions and purchases are tabulated at the user stage for each content in such a manner that the former is distinguished from the latter, it is possible to obtain more accurate sales conditions for each content and provide content distributors with more precise sales measures.

### SECOND EMBODIMENT

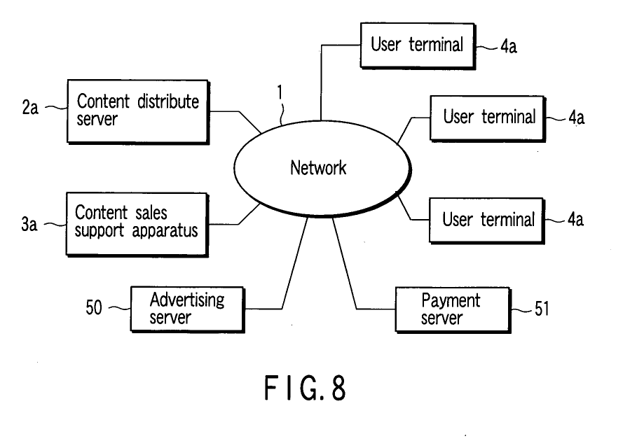

FIG. 8 is a schematic view showing a general configuration of a super distribution system in which a content sales support apparatus according to a second embodiment of the invention has been incorporated. The same parts as those in the super distribution system in which the content sales support apparatus of the first embodiment shown in FIG. 1 has been incorporated are indicated by the same reference numerals and an explanation of the repetitive parts will be omitted.

In the super distribution system of the second embodiment, a content distribute server 2a, a content sales support apparatus 3a, an advertising server 50, a payment server 51, and a plurality of user terminals 4 are connected to a network 1. The content distribute server 2a, content sales support apparatus 3a, advertising server 50, and payment server 51 are operated by a content distributor. Each of the user terminals 4 is managed by the end user of each content.

The advertising server 50 operated by the content distributor displays on its own homepage (HP) various advertisements and a menu of contents the content distribute server 2a can deliver. The menu of contents is linked with the content distribute server 2a.

Then, the user operates his or her user terminal 4a to access the homepage (HP) of the advertising server 50 and specifies the desired content from the menu of contents displayed on the homepage (HP). Then, his or her user terminal 4a is connected to the content distribute server 2a to which the terminal 4a has been connected. As a result, the content distribute server 2a transmits the encrypted content of the content specified by the user terminal 4a.

When content is specified on its homepage (HP), the advertising server 50 transmits to the content sales support apparatus 3a a content possession report composed of the content ID of the specified content and the date of the specification.

After receiving the encrypted content of the specified content from the content distribute server 2a, the user judges whether the encrypted content has to be decrypted. If the encrypted content has to be decrypted, the user operates the user terminal 4a to transmit a key purchase request to the content distribute server 2a. As a result, the user terminal receives the key transmitted from the content distribute server 2a. Receiving the key, the user terminal 4a accesses the payment server 51 and makes payment of charge for the purchased key with the payment server 51.

After finishing payment of charge for the purchased key with the payment server 51, the user operates his or her own user terminal 4a to decrypt the encrypted content using the key and displays the decrypted content.

On the other hand, after finishing the payment of charge for the key with the user terminal 4a, the payment server 51 transmits a content purchase report composed of the content ID of the purchased key and the date of the purchase to the content sales support apparatus 3a.

As described above, the user terminal 4a of the user in the second embodiment transmits neither the content possession report nor content purchase report to the content sales support apparatus 3a.

Using the content possession report received form the advertising server 50 and the content purchase report received from the payment server 51, the content sales support apparatus 3a updates the statistics of the number of possessions of contents and the number of purchases of contents in the index table by content 40, detailed possession table 41, detailed purchase table 42, and overall index table 43 stored in the statistical DB 38.

Then, analyzing each of the updated statistics, the content sales support apparatus 3a determines a proposed sales measure for each content as does the content sales support apparatus 3 of the first embodiment.

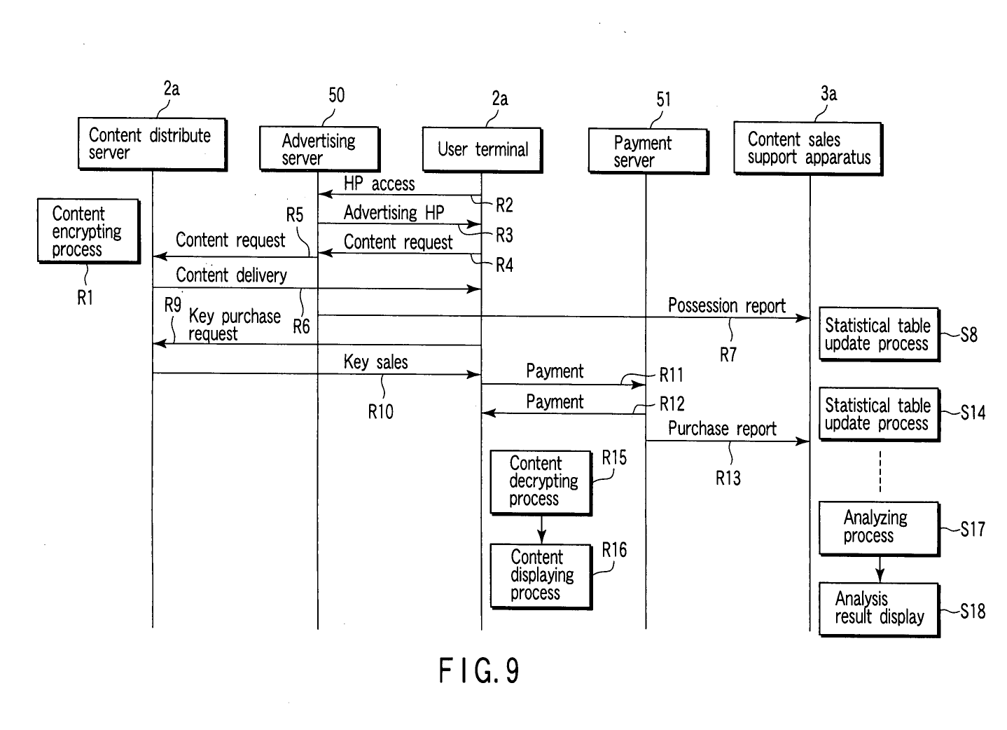

FIG. 9 is a sequence diagram showing the flow of signals between the content distribute server 2a, advertising server 50, user terminal 4a, payment server 51 and content sales support apparatus 3a.

First, the content distribute server 2a encrypts content (step R1). In this state, the user terminal 4a accesses the homepage (HP) of the advertising server 50 (step R2). The advertising server 50 transmits to the user terminal 4a an advertising homepage (HP) on which advertisements and a menu of contents are displayed (step R3).

When the user terminal 4a transmits a content request for one content in the menu to the advertising server 50 (step R4), the content request is transferred to the content distribute server 2a linked with the terminal 4a (step R5). The content distribute server 2a delivers encrypted content to the user terminal 4a (step R6).

Then, the advertising server 50 transmits a content possession report to the content sales support apparatus 3a (step R7). As a result, the content sales support apparatus 3a updates each of the tables 40, 41, 43 (step R8).

When the user terminal 4a transmits a key purchase request to the content distribute server 2a (step R9), the content distribute server 2a sells a key to the terminal 4a (step R10). Next, payment of charge for the key is made between the user terminal 4a and the payment serer 51 (R11, R12). After the payment, the payment server 51 transmits a content purchase report to the content sales support apparatus 3a (step R13). The content sales support apparatus 3a updates each of the tables 40, 42, 43 (step R14).

Thereafter, the user terminal 14a decrypts the encrypted content using the key (step R15) and displays the decrypted content (step R16). On the other hand, the content sales support apparatus 3a analyzes the proposed sales measure for each content (step R17) and displays the obtained proposed sales measure (step R18).

In the super distribute system in which the content sales apparatus 3a of the second embodiment has been incorporated, not only the content distribute server 2a and user terminals 4a but also the advertising server 50 and payment server 51 are connected to the network 1.

Then, when the user terminal 2a receives encrypted content via the advertising server 50, the advertising server 50 transmits a content possession report to the content sales support apparatus 3a. When the user terminal 4a makes payment of charge for the key purchased from the content distribute server 2a with the payment server 51, the payment server 51 transmits a content purchase report to the content sales support apparatus 3a.

Accordingly, receiving the content possession report and content purchase report, the content sales support apparatus 3a analyses the individual updated statistics in each table of the statistical DB 38 and determines a proposed sales measure for each content as does the content sales support apparatus 3 of the first embodiment. Therefore, the content sales support apparatus 3 of the second embodiment provides almost the same operational advantages as those of the first embodiment.

Furthermore, since the advertising server 50 and payment server 51 transmit the content possession report and content purchase report to the content sales support apparatus 3a, the processing burden on the user terminal 4a is alleviated. As a result, it is not necessary to write a special program into the user terminal 4a and a commercially available Internet browser has only to be installed. Moreover, the user is not forced to pay extra communication expenses, which improves service to the user.

The invention is not limited to the above embodiments. In the second embodiment, each user terminal 4a obtains encrypted content from the advertising server 50 linked with the content distribute server 2a. However, encrypted content may be stored in the advertising server 50 in advance and the stored encrypted content may be delivered to each user terminal 4a.

In addition, a P2P (pear to pear) software program which enables the encrypted content to be transmitted and received to and from the general public on the Internet may be incorporated in each user terminal 4a.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A content sales support method of supporting the sale of contents in a super distribution system where a content distribute server delivers encrypted content obtained by encrypting content and a key for decrypting the encrypted content to a plurality of user terminals separately free of charge or for profit, the content sales support method comprising:
a step of finding the number of possessions for each content of the encrypted contents stored at the user terminals;
a step of finding the number of purchases for each content of the keys purchased at the user terminals; and
a step of determining a sales measure for each content on the basis of at least the result of comparison between the found number of purchases of keys for each content and the number of possessions of encrypted content.

2. A content sales support method of supporting the sale of contents in a super distribution system where a content distribute server delivers encrypted content obtained by encrypting content and a key for decrypting the encrypted content to a plurality of user terminals separately free of charge or for profit, the content sales support method comprising:
a step of finding the number of possessions for each content of the encrypted contents stored held at the user terminals and the average number of possessions of contents;
a step of finding the number of purchases for each content of the keys purchased at the user terminals and the average number of purchases of contents; and
a step of determining a sales measure for each content on the basis of at least the result of comparison between the found number of purchases of keys for each content, the number of possessions of encrypted contents, the average number of possessions, and the average number of purchases.

3. The content sales support method according to claim 2, further comprising a step of finding a purchase ratio obtained by dividing the number of purchases of keys for each content by the number of possessions of encrypted content,
wherein the step of determining a sales measure for each of the contents is
(a) to determine on a sales measure “to reexamine the part allowed to be previewed or consider purchase bonuses” if the number of possessions of the relevant content is larger than the average number of possessions, the number of purchases is larger than the average number of purchases, and the purchase ratio is smaller than 0.5,
(b) to determine on a sales measure “to reexamine the sales price” if the number of possessions of the relevant content is larger than the average number of possessions, the number of purchases is smaller than the average number of purchases, and the purchase ratio is smaller than 0.5,
(c) to determine on a sales measure “to increase the exposures in number” if the number of possessions of the relevant content is smaller than the average number of possessions, the number of purchases is smaller than the average number of purchases, and the purchase ratio is larger than 0.5, and
(d) to determine on a sales measure “to perform overall review” if the number of possessions of the relevant content is smaller than the average number of possessions, the number of purchases is smaller than the average number of purchases, and the purchase ratio is smaller than 0.5.

4. The content sales support method according to claim 2, further comprising a step of providing a statistic storage section which stores the statistics of the number of possessions of each content and the number of purchases of a key for content at a user terminal,
the step of finding the number of possessions of each content and the average number of possessions of content includes a step of updating the number of possessions of content in the statistic storage section when receiving from the user terminal a possession report of newly possessing encrypted content, and
the step of finding the number of purchases of keys for each content and the average number of purchases of keys for the contents includes a step of updating the number of purchases of keys for the contents at the statistic storage section when receiving from the user terminal a purchase report of having newly purchased a key.

5. A content sales support apparatus which is incorporated into a super distribution system where a content distribute server delivers encrypted content obtained by encrypting content and a key for decrypting the encrypted content to a plurality of user terminals separately free of charge or for profit and which supports the sale of contents, the content sales support apparatus comprising:
means for finding the number of possessions for each content of the encrypted contents stored at the user terminals and the average number of possessions of contents;
means for finding the number of purchases for each content of the keys purchased at the user terminals and the average number of purchases of contents;
means for finding a purchase ratio obtained by dividing the number of purchases of keys for each content by the number of possessions of encrypted content, and
means for determining a sales measure for each content on the basis of the result of comparison between the found number of purchases for each content, the number of possessions of encrypted content, the purchase ratio, the average number of possessions, and the average number of purchases.

6. The content sales support apparatus according to claim 5, further comprising a statistic storage section which stores the statistics of the number of possessions of each content and the number of purchases of a key for content at a user terminal,
wherein the means for finding the number of possessions of each content and the average number of possessions of content includes means for updating the number of possessions of content at the statistic storage section when receiving from the user terminal a possession report of having newly possessed encrypted content, and
the means for finding the number of purchases of keys for contents and the average number of purchases of keys include means for updating the number of purchases of keys for contents at the statistic storage section when receiving from the user terminal a purchase report of having newly purchased a key.

7. A content sales support apparatus which is incorporated in a super distribution system where a content distribute server delivers not only encrypted content obtained by encrypting content to a plurality of user terminals via an advertising server but also a key for decrypting the encrypted content to the user terminals and the payment of charge for the key is made between a payment server and the user terminals and which supports the sale of contents, the content sales support apparatus comprising:
means for finding the number of possessions for each content of the encrypted contents stored at the user terminals and the average number of possessions of contents;
means for finding the number of purchases for each content of the keys purchased at the user terminals and the average number of purchases of contents;
means for finding a purchase ratio obtained by dividing the number of purchases of keys for each content and the number of possessions of encrypted content, and
means for determining a sales measure for each content on the basis of the result of comparison between the found number of purchases for each content, the number of possessions of encrypted content, the purchase ratio, the average number of possessions, and the average number of purchases.

8. The content sales support apparatus according to claim 7, further comprising a statistic storage section which stores the statistics of the number of possessions of each content and the number of purchases of a key for content at a user terminal,
wherein the means for finding the number of possessions of each content and the average number of possessions of content includes means for updating the number of possessions of content at the statistic storage section when receiving from the advertising server a possession report of having newly possessed encrypted content, and
the means for finding the number of purchases of keys for contents and the average number of purchases of keys includes means for updating the number of purchases of keys for contents at the statistic storage section when receiving from the payment server a purchase report that the user terminal has newly purchased a key.

9. A super distribution system including;
a content distribute server, a plurality of user terminals, and a content sales support apparatus, and
the content distribute server comprising means for delivering encrypted content obtained by encrypting content to the individual user terminals free of charge and means for sending a key for decrypting the encrypted content to the user terminals for profit,
each of the user terminals comprising means for storing the encrypted content delivered free of charge from the content distribute server and means for decrypting the encrypted content into the original content using the key transmitted for profit from the content distribute server, and
the content sales support apparatus comprising means for, on the basis of a report of the number of possessions of encrypted content from each of the user terminals and a report of the number of purchases of keys, finding the number of possessions for each content of the encrypted contents stored at the user terminals and the average number of possessions of contents and the number of purchases for each content of the keys purchased at the user terminals and the average number of purchases of contents, and means for determining a sales measure for each content on the basis of the result of comparison between the found number of purchases of keys for the individual contents, the number of possessions of encrypted content, the average number of possessions, and the average number of purchases.

10. A super distribution system including;
a content distribute server, an advertising server, a plurality of user terminals, a payment server, and a content sales support apparatus, and
the advertising server comprising means for displaying on a homepage a menu of contents distributable by the content distribute server, means for transferring a content transmission request from a user terminal to the content distribute server, and means for transmitting a content possession report to the content sales support apparatus,
the content distribute server comprising means for transmitting encrypted content of specified content to the user terminal of the content transmission requester according to the content transmission request from the advertising server and means for transmitting a key for decrypting the encrypted content according to a key purchase request from the user terminal,
the payment server comprising means for making payment of charge for the key with the user terminal and means for transmitting a content purchase report of the content to the content sales support apparatus,
each of the user terminals comprising means for transmitting a content transmission request to the advertising server, means for transmitting a key purchase request to the content distribute server, means for making payment of charge for the key with the payment server, and means for decrypting the encrypted content into the original content using the key received from the content distribute server, and
the content sales support apparatus comprising means for, on the basis of a content possession report from the advertising server and a purchase report from a payment server, finding the number of possessions for each content of the encrypted contents stored at the user terminals and the average number of contents and the number of purchases for each content of the keys purchased at the user terminals and the average number of purchases of contents, and means for determining a sales measure for each content on the basis of the result of comparison between the found number of purchases for each content of keys for the individual contents, the number of possessions of encrypted content, the average number of possessions, and the average number of purchases.

11. A content sales support program product which is configured in a super distribution system where a content distribute server delivers encrypted content obtained by encrypting content and a key for decrypting the encrypted content to a plurality of user terminals separately free of charge or for profit and which supports the sale of contents, the content sales support program product comprising:
finding the number of possessions for each content of the encrypted contents stored at the user terminals and the average number of possessions of contents;
finding the number of purchases for each content of the keys purchased at the user terminals and the average number of purchases of contents;
finding a purchase ratio obtained by dividing the number of purchases of a key for each content by the number of possessions of encrypted content, and
determining a sales measure for each content on the basis of the result of comparison between the found number of purchases of a key for each content, the number of possessions of encrypted content, the purchase ratio, the average number of possessions, and the average number of purchases.
